(19) United States
(12) Patent Application Publication
(10) Pub. No.: US 2020/0310968 A1
(43) Pub. Date: Oct. 1, 2020

(54) APPARATUS AND METHOD FOR TRANSMITTING GARBAGE COLLECTION STATUS INFORMATION IN A MEMORY SYSTEM

(71) Applicant: SK hynix Inc., Gyeonggi-do (KR)

(72) Inventor: Byung-Jun KIM, Gyeonggi-do (KR)

(21) Appl. No.: 16/575,704

(22) Filed: Sep. 19, 2019

(30) Foreign Application Priority Data
Mar. 27, 2019 (KR) 10-2019-0035004

(51) Int. Cl. G06F 12/02

(52) U.S. Cl. CPC G06F 12/0261; G06F 2212/1044

(57) ABSTRACT

A memory system may include: a nonvolatile memory device including a plurality of memory blocks; and a controller suitable for checking the number of free blocks among the plurality of memory blocks, generating or updating status information depending on a checking result, and outputting the status information by including the status information in a response to be outputted to a host depending on an operation corresponding to a command inputted from the host.

### CROSS-REFERENCE TO RELATED APPLICATION

This application claims priority under 35 U.S.C. § 119 to Korean Patent Application No. 10-2019-0035004 filed on Mar. 27, 2019, which is incorporated herein by reference in its entirety.

### BACKGROUND

### 1. Field

Various embodiments relate to a memory system, and more particularly, to an apparatus and method in which a memory system included in a data processing system transmits garbage collection status information to a host or a computing device.

### 2. Discussion of the Related Art

The computer environment paradigm has changed to ubiquitous computing systems that can be used anytime and anywhere. As a result, use of portable electronic devices such as mobile phones, digital cameras, and notebook computers has rapidly increased. These portable electronic devices generally use a memory system having one or more memory devices for storing data. A memory system may be used as a main or an auxiliary storage device of a portable electronic device.

Memory systems provide excellent stability, durability, high information access speed, and low power consumption because they have no moving parts. Examples of memory systems having such advantages include universal serial bus (USB) memory devices, memory cards having various interfaces, and solid state drives (SSD).

### SUMMARY

Various embodiments are directed to a data processing system and an operating method thereof for transfer of data between components in a data processing system including components or resources such as a memory system and a host.

Also, various embodiments are directed to an apparatus and method in which a memory system in a data processing system may transmit free space status information to a host or a computing device and the host or the computing device may transmit a command for garbage collection to the memory system corresponding to the free space status information in the memory system, thereby effectively securing free space of the memory system.

Further, various embodiments are directed to an apparatus and method in which a memory system in a data processing system may transmit an acknowledgement corresponding to a command inputted from a host or a computing device, to the host or the computing device, by including free space status information in the acknowledgement, and the host or the computing device may be aware of the need for garbage collection in the memory system and directly control whether to perform garbage collection so that the host or the computing device may adjust the size or status of the free space of the memory system, thereby preventing the deterioration of the input/output performance and endurance of the memory system due to the lack of free space.

It is to be understood that technical objects to be achieved by the disclosure are not limited to the aforementioned technical objects and other technical objects which are not mentioned herein will be apparent from the following description to one of ordinary skill in the art to which the disclosure pertains.

In an embodiment, a memory system may include: a nonvolatile memory device including a plurality of memory blocks; and a controller suitable for checking a number of free blocks among the plurality of memory blocks, generating or updating status information depending on a result of the checking, and outputting the status information by including the status information in a response to be outputted to a host in response to a command inputted from the host.

The controller may generate the status information when the number of free blocks among the blocks is less than a first preset reference.

The controller may update the status information when the number of free blocks among the blocks changes by an amount greater than or equal o a second preset reference.

The controller may output the status information by including the status information in the response when the generated or updated status information exists after the operation corresponding to the command inputted from the host is performed.

The response may include a flag, and the controller may set the flag when the status information is included in the response.

In an embodiment, a data processing system may include: a host suitable for generating and outputting a command; and a memory system including a nonvolatile memory device which includes a plurality of memory blocks, the memory system may check a number of free blocks among the plurality of memory blocks, and generates or updates status information depending on a result of the checking, the memory system may output the status information by is including the status information in a response to be outputted to the host in response to a command inputted from the host, and the host may selectively generate a garbage collection command depending on the status information transferred from the memory system, and may output the garbage collection command to the memory system at a time determined by the host.

The memory system may generate the status information when the number of free blocks among the blocks is less than a first preset reference.

The memory system may update the status information when the number of free blocks among the blocks changes by an amount greater than or equal to a second preset reference.

The memory system may output the status information by including the status information in the response when the generated or updated status information exists after the operation corresponding to the command inputted from the host is performed.

The host may check the status information included in the response.

The response may include a flag, and the memory system may set the flag when the status information is included in the response.

The host may check the flag included in the response, may check the status information included in the response when the flag is in a set state, may selectively generate the garbage collection command depending on a result of the checking of the status is information and outputs the garbage collection command to the memory system at a time determined by the host.

The host may generate the garbage collection command when the number of free blocks among the memory blocks is less than a third preset reference, and the third preset reference may be less than the first preset reference.

In an embodiment, a method for operating a memory system including a nonvolatile memory device which includes a plurality of memory blocks, the method may include: checking a number of free blocks among the memory blocks and generating or updating status information depending on a result of the checking; and outputting the status information by including the status information in a response to be outputted to a host in response to a command inputted from the host.

Checking the number of free blocks may include: a first checking step of checking whether the number of free blocks among the memory blocks is less than a first preset reference; and generating the status information when the number of free blocks is less than the first preset reference.

Checking the number of free blocks may further include: a second checking step of checking whether the number of free blocks among the memory blocks changes by an amount greater than or equal to a second preset reference; and updating the status information when the number of free blocks changes by an amount is greater than or equal to the second preset reference.

Outputting the status information may include: a third checking step of checking whether the generated or updated status information exists; and outputting the status information by including the status information in the response when the generated or updated status information exists.

The response may include a flag, and outputting the status information may further include setting the flag when the status information is included in the response.

In an embodiment, a method for operating a data processing system including a host capable of generating and outputting a command, and a memory system including a nonvolatile memory device which includes a plurality of memory blocks, the method may include: checking, by the memory system, a number of free blocks among the memory blocks and generating or updating, by the memory system, status information depending on a result of checking the number of free blocks; generating, by the host, a command and outputting, by the host, the command to the memory system; a first outputting step of including, by the memory system, the status information in a response to be outputted to the host after performing an operation in response to the command; and a second outputting step of checking, by the host, the status information included in the response, selectively generating, by the host, a garbage collection command depending on a result of checking the status information and outputting the garbage collection command to the memory system at a time determined by the host.

Checking, by the memory system, a number of free blocks may include: a first checking step of checking whether the number of free blocks among the memory blocks is less than a first preset reference; and generating the status information when the number of free blocks is less than the first preset reference.

Checking, by the memory system, a number of free blocks may further include: a second checking step of checking whether the number of free blocks among the memory blocks changes by and amount greater than or equal to a second preset reference; and updating the status information when the number of free blocks changes by an amount greater than or equal to the second preset reference.

The first outputting step may include: a third checking step of checking whether the generated or updated status information exists; and outputting the status information by including the status information in the response when the generated or updated status information exists.

The response may include a flag, and the second outputting step may include: a fourth checking step of checking the flag by the host; and checking, by the host, the status information included in the response and selectively generating, by the host, the garbage collection command depending on a result of the checking the status is information and outputting, by the host, the garbage collection command to the memory system, when the flag is in a set state and at a time determined by the host.

The garbage collection command may be generated when the number of free blocks among the memory blocks is less than a third preset reference, and the third preset reference may be less than the first preset reference.

In an embodiment, an operating method of a data processing system including a host and a memory system, the operating method may include: performing, by the memory system, an operation in response to a request provided from the host; providing, by the memory system, the host with information of currently available memory space thereof along with a response to the request; and selectively controlling, by the host, the memory system to secure available memory space thereof based on the information and at a time determined by the host.

The information may be provided when the currently available memory space is under a first threshold.

The host may control the memory system to secure the available memory space when the currently available memory space is under a second threshold less than the first threshold.

In an embodiment, an operating method of a memory system, the operating method may include: performing an operation in response to a first request provided from a host; providing the host with information of currently available memory space thereof along with a response to the first request; and securing available memory space thereof in response to a second request provided from the host.

The information may be provided when the currently available memory space is under a first threshold.

The available memory space may be secured in response to the second request when the currently available memory space is under a second threshold less than the first threshold.

The effects of the apparatus according to the embodiments of the disclosure are as follows.

In the data processing system according to the embodiments of the disclosure, a host or a computing device may control whether to perform garbage collection for a memory system, by referring to free space information which is inputted from the memory system. Thus, when compared to when the memory system performs garbage collection as a background operation, it is possible to stably secure an operation window, that is, a margin, for garbage collection. Because garbage collection may be sufficiently performed through control of the host or the computing device, it is possible to avoid the deterioration of the input/output performance and endurance of the memory system.

Also, in the embodiments of the disclosure, because the memory system may transmit an acknowledgement corresponding to a command inputted from the host or the computing device, to the host or the computing device, by including free space information in the acknowledgement, it is not necessary for the host or the computing device to perform a separate operation to check the free space information of the memory system.

### BRIEF DESCRIPTION OF THE DRAWINGS

FIG. 1 is a diagram schematically illustrating a data processing system including a memory system in accordance with an embodiment of the disclosure.

FIG. 2 is a diagram illustrating a controller in the memory system in accordance with the embodiment of the disclosure.

FIG. 3 is a diagram illustrating garbage collection used in the memory system in accordance with the embodiment of the disclosure.

FIG. 4 is a diagram illustrating a program operation and garbage collection of the memory system in accordance with the embodiment of the disclosure.

FIG. 5 is a diagram of a method for transmitting status information for garbage collection in accordance with an embodiment of the disclosure.

FIG. 6 is a diagram of a transaction of a host and the memory system in the data processing system in accordance with the embodiment of the disclosure.

FIG. 7 is a diagram of a first operation of the host and the memory system in accordance with the embodiment of the disclosure.

FIG. 8 is a diagram of a second operation of the host and the memory system in accordance with the embodiment of the disclosure.

FIG. 9 is a diagram of a third operation of the host and the memory system in accordance with the embodiment of the disclosure.

FIG. 10 is a diagram of a fourth operation of the host and the memory system in accordance with the embodiment of the disclosure.

### DETAILED DESCRIPTION

Various embodiments are described below in more detail with reference to the accompanying drawings. The present invention may, however, be embodied in different forms and should not be construed as limited to the embodiments set forth herein. Rather, these embodiments are provided so that this disclosure is thorough and complete and fully conveys the scope of the present invention to those skilled in the art. Throughout the disclosure, like reference numerals refer to like parts throughout the various figures and embodiments of the present invention. Throughout the specification, reference to “an embodiment,” “another embodiment” or the like is not necessarily to only one embodiment, and different references to any such phrase are not necessarily to the same embodiment(s).

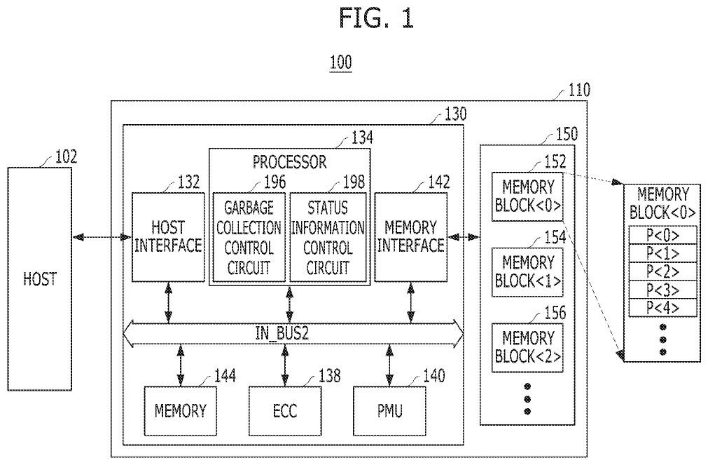

FIG. 1 is a diagram illustrating a data processing system 100 in accordance with an embodiment.

Referring to FIG. 1, the data processing system 100 may include a host 102 and a memory system 110.

The host 102 includes electronic devices, for example, portable electronic devices such as a mobile phone, an MP3 player and a laptop computer or electronic devices such as a desktop computer, a game machine, a television (TV) and a projector, that is, wired and wireless electronic devices.

The host 102 includes at least one operating system (OS). The operating system generally manages and controls the function and operation of the host 102, and provides interoperability between the host 102 and a user using the data processing system 100 or the memory system 110. The operating system supports functions and operations corresponding to the user's purpose of use and the use of the operating system. For example, the operating system may be classified into a general operating system and a mobile operating system depending on the mobility of the host 102. Also, the general operating system may be classified into a personal operating system and an enterprise operating system depending on the user's usage environment. For example, the personal operating system characterized to support a service providing function for a general user may include Windows and Chrome, and the enterprise operating system characterized to secure and support high performance may include Windows server, Linux and Unix. In addition, the mobile operating system characterized to support a mobility service providing function and a system power saving function to users may include Android, iOS, Windows mobile, etc. The host 102 may include a plurality of operating systems, and executes the operating systems to perform operations with the memory system 110 corresponding to a user request. The host 102 transmits a plurality of commands corresponding to a user request to the memory system 110, and accordingly, the memory system 110 performs operations corresponding to the commands, that is, operations corresponding to the user request.

The memory system 110 operates in response to a request of the host 102, in particular, stores data to be accessed by the host 102. The memory system 110 may be used as a main memory device or an auxiliary memory device of the host 102. The memory system 110 may be realized as any one of various types of storage devices, depending on a host interface protocol which is coupled with the host 102. For example, the memory system 110 may be realized as any one of a solid state drive (SSD), a multimedia card in the form of an MMC, an embedded MMC (eMMC), a reduced size MMC (RS-MMC) and a micro-MMC, a secure digital card in the form of an SD, a mini-SD and a micro-SD, a universal serial bus (USB) storage device, a universal flash storage (UFS) device, a compact flash (CF) card, a smart media card, or a memory stick.

The storage devices which realize the memory system 110 may be realized by a volatile memory device such as a dynamic random access memory (DRAM) and a static random access memory (SRAM) or a nonvolatile memory device such as a read only memory (ROM), a mask ROM (MROM), a programmable ROM (PROM), an erasable programmable ROM (EPROM), an electrically erasable and programmable ROM (EEPROM), an ferroelectric random access memory (FRAM), a phase change RAM (PRAM), a magnetic RAM (MRAM) and/or a resistive RAM (RRAM).

The memory system 110 includes a memory device 150 which stores data to be accessed by the host 102, and a controller 130 which controls storage of data in the memory device 150.

The controller 130 and the memory device 150 may be integrated into one semiconductor device to configure an SSD. When the memory system 110 is used as an SSD, the operating speed of the host 102 which is coupled to the memory system 110 may be improved. In another embodiment, the controller 130 and the memory device 150 may be integrated into one semiconductor device to configure a memory card, such as a PC card (e.g., Personal Computer Memory Card International Association (PCMCIA) card), a compact flash card (CF), a smart media card (e.g., SM and SMC), a memory stick, a multimedia card (e.g, MMC, RS-MMC and MMCmicro), a secure digital (SD) card (e.g., SD, miniSD, microSD and SDHC) and/or a universal flash storage (UFS).

In another embodiment, the memory system 110 may configure a computer, an ultra mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, an RFID (radio frequency identification) device, or one of various component elements configuring a computing system.

The memory device 150 may retain stored data even though power is not supplied. In particular, the memory device 150 stores the data provided from the host 102, through a write operation, and provides stored data to the host 102, through a read operation. The memory device 150 may include a plurality of memory blocks 152, 154 and 156. Each of the memory blocks 152, 154 and 156 may include a plurality of pages including P<0> to P<4>. Each of the pages including P<0> to P<4> may include a plurality of memory cells. The memory blocks 152, 154 and 156 include page buffers for caching data to be inputted/outputted, by the unit of a page. The memory device 150 may include a plurality of planes, in each of which some of the plurality of memory blocks 152, 154 and 156 are included. The memory device 150 may include a plurality of memory dies, in each of which one or more of the plurality of planes are included. The memory device 150 may be a nonvolatile memory device, for example, a flash memory, and the flash memory may have a three-dimensional (3D) stack structure.

The controller 130 in the memory system 110 may control the memory device 150 in response to a request from the host 102. For example, the controller 130 may provide data read from the memory device 150, to the host 102, and may store data provided from the host 102, in the memory device 150. To this end, the controller 130 may control read, write, program, and erase operations of the memory device 150.

In detail, the controller 130 may include a host interface unit 132, a processor 134, an error correction code (ECC) unit 138, a power management unit (PMU) 140, a memory interface unit 142 and a memory 144.

The host interface 132 processes the commands and data of the host 102. The host interface 132 may be configured to communicate with the host 102 through at least one of various interface protocols, such as universal serial bus (USB), multimedia card (MMC), peripheral component interconnect-express (PCI-e or PCIe), serial attached SCSI (SAS), serial advanced technology attachment (SATA), parallel advanced technology attachment (DATA), small computer system interface (SCSI), enhanced small disk interface (ESDI), integrated drive electronics (IDE) and mobile industry processor interface (MIPI). The host interface 132 may be driven through a firmware referred to as a host interface layer (HIL) being a region which exchanges data with the host 102.

The ECC unit 138 may correct an error bit of data processed in the memory device 150, and may include an ECC encoder and an ECC decoder. The ECC encoder may perform error correction encoding for data to be programmed in the memory device 150 and generate data with parity bits added. The data added with parity bits may be stored in the memory device 150. The ECC decoder detects and corrects an error included in data read from the memory device 150, in the case of reading data stored in the memory device 150. That is, after performing error correction decoding for data read from the memory device 150, the ECC unit 138 may determine whether the error correction decoding has succeeded, may output an indication signal depending on a determination result, for example, an error correction success/failure signal, and may correct an error bit of the read data by using the parity bits generated in the ECC encoding process. The ECC unit 138 cannot correct error bits when the number of occurred error bits is greater than or equal to a correctable error bit limit, and may output an error correction failure signal corresponding to the incapability of correcting error bits.

The ECC unit 138 may perform error correction by using, but not limited to, an LDPC (low density parity check) code, a BCH (Bose, Chaudhuri, Hocquenghem) code, a turbo code, a Reed-Solomon code, a convolution code, an RSC (recursive systematic code), or a coded modulation such as a TCM (trellis-coded modulation) or a BCM (block coded modulation). The ECC unit 138 may include a circuit, a module, a system or a device for error correction.

The PMU 140 provides and manages power for the controller 130, that is, power for the components included in the controller 130.

Further, the memory interface unit 142 serves as a memory/storage interface which performs interfacing between the controller 130 and the memory device 150. The memory interface 142 may allow the controller 130 to control the memory device 150 in response to a request from the host 102. The memory interface 142 generates control signals for the memory device 150 and processes data under the control of the processor 134. The memory interface 142 is, or functions as, a NAND flash controller (NFC) in the case where the memory device 150 is a flash memory, in particular, in the case where the memory device 150 is a NAND flash memory. The memory interface 142 may support the operation of an interface which processes a command and data between the controller 130 and the memory device 150, for example, a NAND flash interface. In particular, the memory interface 142 processes data input/output between the controller 130 and the memory device 150. The memory interface 142 may be driven through a firmware referred to as a flash interface layer (FIL) being a region which exchanges data with the memory device 150.

The memory 144, as the working memory of the memory system 110 and the controller 130, may store data for driving of the memory system 110 and the controller 130. In detail, the memory 144 may temporarily store data read from the memory device 150 during a process in which the controller 130 controls the memory device 150 in response to a request from the host 102, before providing the read data to the host 102. Also, the controller 130 may temporarily store data provided from the host 102, in the memory 144, before storing the data in the memory device 150. When the controller 130 controls read, write, program, and erase operations of the memory device 150, data to be transferred or generated between the controller 130 and the memory device 150 in the memory system 110 may be stored in the memory 144. For example, the memory 144 may store data necessary to perform data write and read operations between the host 102 and the memory device 150 and data when performing the data write and read operations. For such data storage, the memory 144 may include a program memory, a data memory, a write buffer/cache, a read buffer/cache, a data buffer/cache, a map buffer/cache, and so forth.

The memory 144 may be realized by a volatile memory. For example, the memory 144 may be realized by a static random access memory (SRAM) or a dynamic random access memory (DRAM). The memory 144 may exist inside the controller 130 as illustrated in the drawing. Alternatively, the memory 144 may exist outside the controller 130 unlike the illustration of the drawing. In this case, the memory 144 may be realized as an external volatile memory to and from which data is inputted and outputted from and to the controller 130 through a separate memory interface.

The processor 134 controls the entire operations of the memory system 110. In particular, the processor 134 controls a program operation or a read operation for the memory device 150, in response to a write request or a read request from the host 102. The processor 134 drives firmware which is referred to as a flash translation layer (FTL), to control general operations of the memory system 110. The processor 134 may be realized by a microprocessor or a central processing unit (CPU).

For instance, the controller 130 performs an operation requested from the host 102, in the memory device 150. That is, the controller 130 performs a command operation corresponding to a command received from the host 102, with the memory device 150, through the processor 134 embodied by a microprocessor or a central processing unit (CPU). The controller 130 may perform a foreground operation as a command operation corresponding to a command received from the host 102. For example, the controller 130 may perform a program operation corresponding to a write command, a read operation corresponding to a read command, an erase operation corresponding to an erase command, or a parameter set operation corresponding to a set parameter command or a set feature command as a set command.

The processor 134 may include therein a garbage collection control circuit 196 to control garbage collection as a background operation for the memory device 150.

The controller 130 may also perform a background operation for the memory device 150, through the processor 134 embodied by a microprocessor or a central processing unit (CPU). The background operation for the memory device 150 may include an operation of copying data stored in a memory block among the memory blocks 152, 154 and 156 of the memory device 150 to another memory block, for example, a garbage collection (GC) operation. Since the processor 134 may control a garbage collection operation as a background operation for the memory device 150, a garbage collection control circuit 196 may be included in the processor 134. The background operation may include an operation of swapping data between one or more of the memory blocks 152, 154 and 156 of the memory device 150, for example, a wear leveling (WL) operation. The background operation may include an operation of storing map data retrieved from the controller 130 in the memory blocks 152, 154 and 156 of the memory device 150, for example, a map flush operation. The background operation may include a bad management operation for the memory device 150, which may include checking for and processing a bad block among the plurality of memory blocks 152, 154 and 156 in the memory device 150.

According to an embodiment, the controller 130 may check status of the memory device 150, and then, may control a background operation for the memory device 150 depending on a result of the checking. According to an embodiment, the controller 130 may control a background operation for the memory device 150 in response to a command inputted from the host 102. According to an embodiment, the controller 130 may output a result of checking the status of the memory device 150 to the host 102, and may control a background operation for the memory device 150 in response to a command inputted from the host 102. The result of checking the status of the memory device 150 may be a number of free blocks within the memory device 150. In this regard, the host 102 may generate a command to be outputted to the controller 130, by referring to the result of checking the status of the memory device 150. For example, the controller 130 may control garbage collection for the memory device 150 through the garbage collection control circuit 196 even in the case where a command is not inputted from the host 102. The controller 130 may generate or update status information by checking the number of free blocks included in the memory device 150, through status information control circuit 198, and the generated or updated status information may be outputted to the host 102 through the host interface 132. The host 102 may generate a garbage collection command to be outputted to the controller 130, by referring to the status information inputted from the controller 130. The controller 130 may control a garbage collection operation for the memory device 150 through the garbage collection control circuit 196 when the garage collection command is inputted from the host 102.

Within the processor 134 of the controller 130, a component for performing bad block management for the memory device 150 may be included. Such component performs bad block management of checking for a bad block among the plurality of memory blocks 152, 154 and 156 and processing the identified bad block as a bad. Through bad block management, a memory block in which a program fail has occurred is processed as a bad memory block, and program-failed data is written in a new memory block. The bad block management may be performed when a program fail may occur when performing data write (or program), due to the characteristic of the memory device 150 (e.g., a NAND flash memory).

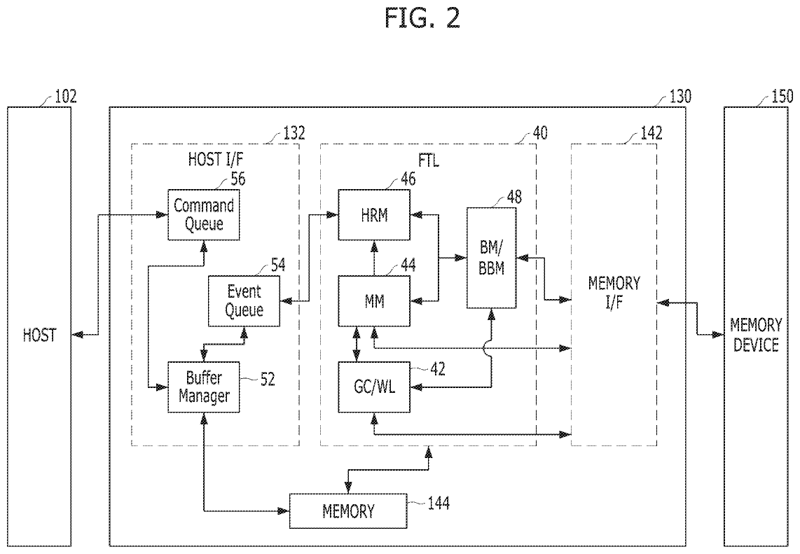

FIG. 2 is a diagram illustrating a controller, e.g., that is shown in FIG. 1, of a memory system in accordance with an embodiment.

Referring to FIG. 2, the controller 130 interacts with the host 102 and the memory device 150. The controller 130 may include a host interface (I/F) 132, a flash translation layer (FTL) 40, a memory interface 142 and a memory 144.

Although not shown in FIG. 2, in accordance with an embodiment, the ECC unit 138 described in FIG. 1 may be included in the flash translation layer (FTL) unit 40. In another embodiment, the ECC unit 138 may be implemented as a separate module, a circuit, a firmware, or the like, which is included in, or associated with, the controller 130.

The host interface 132 handles commands and data, which are received from the host 102. By way of example but not limitation, the host interface 132 may include a buffer manager 52, an event queue 54, and a command queue 56. The command queue 56 may sequentially store the commands and the data, and output the commands and the data to the buffer manager 52 in an order in which the commands and data are stored in the command queue 56. The buffer manager 52 may classify, manage or adjust the commands and the data, which are delivered from the command queue 56. The event queue 54 may sequentially transmit events for processing the commands and the data, which are received from the buffer manager 52.

The memory system 110 may receive a plurality of commands or data having the same characteristic, or a plurality of commands and data having different characteristics after being mixed or jumbled. For example, the memory system 110 receives a plurality of commands for reading data (i.e., read commands), or alternatively receives a plurality of commands for reading data (i.e., read commands) and programming/writing data (i.e., write commands). The host interface 132 may store commands and data, which are received from the host 102, to the command queue 56 sequentially. Thereafter, the host interface 132 may estimate or predict what type of operation the controller 130 will perform according to the characteristics of the command and data. The host interface 132 may determine a processing order and a priority of commands and data, based at least on their characteristics. According to characteristics of the commands and data, the buffer manager 52 may determine whether to store the commands and data in the memory 144, or whether to deliver the commands and the data into the flash translation layer 40. The event queue 54 receives events, entered from the buffer manager 52, which are to be internally executed and processed by the memory system 110 or the controller 130 in response to the commands and the data, so as to deliver the events into the flash translation layer 40 in the order received.

In accordance with an embodiment, the flash translation layer 40 may include a state manager 42, a map manager (MM) 44, a host request manager (HRM) 46, and a block manager 48. The host request manager 46 may manage the events entered from the event queue 54. The map manager 44 may handle or control a map data. The state manager 42 may perform garbage collection (GC) or wear leveling (WL). The block manager 48 may execute commands or instructions onto a block in the memory device 150.

By way of example but not limitation, the host request manager 46 may use the map manager 44 and the block manager 48 to handle or process requests according to the read and program commands, and events which are delivered from the host interface 132. The host request manager 46 may send an inquiry request to the map data manager 44, to determine a physical address corresponding to a logical address which is entered with the events. The host request manager 46 may transmit a read request with the physical address to the memory interface 142, to process the read request (or handle the events). Furthermore, the host request manager 46 may transmit a program request (or write request) to the block manager 48, to program data to a specific free page (Le., a page having no data) in the memory device 150. Additionally, the host request manager 46 may transmit a map update request corresponding to the program request to the map manager 44, to update an item relevant to the programmed data in mapping information. The mapping information may indicate a mapping relationship between logical addresses and physical addresses.

The block manager 48 may convert a program request which is delivered from the host request manager 46, the map data manager 44, and/or the state manager 42, into a flash program request used for the memory device 150, to manage flash blocks in the memory device 150. To maximize or enhance program or write performance of the memory system 110, the block manager 48 may collect program requests and send flash program requests for multiple-plane and one-shot program operations to the memory interface 142. The block manager 48 may send several flash program requests to the memory interface 142 to enhance or maximize parallel processing of a multi-channel and multi-directional flash controller.

The block manager 48 may manage blocks of the memory device 150 according to the number of valid pages. Further, the block manager 48 may select and erase blocks having no valid pages when a free block is needed, and select a block including the least number of valid pages when it is determined that garbage collection is necessary. The state manager 42 may perform garbage collection to move the valid data to an empty block, and erase the blocks that used to contain the valid data so that the block manager 48 may have enough free blocks (i.e., empty blocks with no data). If the block manager 48 provides information regarding a block to be erased to the state manager 42, the state manager 42 may check all flash pages of the block to be erased to determine whether each page is valid. For example, to determine validity of each page, the state manager 42 may identify a logical address stored in an out-of-band (OOB) area of each page. To determine whether each page is valid, the state manager 42 may compare the physical address of the page with the physical address mapped to the logical address obtained from the inquiry request. The state manager 42 sends a program request to the block manager 48 for each valid page. A mapping table may be updated through the update of the map manager 44 when the program operation is completed.

The map manager 44 may manage a logical-to-physical mapping table. The map manager 44 may process requests such as queries and updates, which are generated by the host request manager 46 or the state manager 42. The map manager 44 may store the entire mapping table in the memory device 150 and cache mapping entries according to the storage capacity of the memory 144. When a map cache miss occurs while processing inquiry or update requests, the map manager 44 may send a read request to the memory interface 142 to load a relevant mapping table stored in the memory device 150. When the number of dirty cache blocks exceeds a certain threshold, the map manager 44 may transmit a program request to the block manager 48 so that a clean cache block is generated. Furthermore, the dirty mapping table may be stored in the memory device 150.

When garbage collection is performed, the state manager 42 copies valid page(s) into a free block, and the host request manager 46 may program the latest version of the data for the same logical address of the page, and currently issue an update request. When the state manager 42 requests the map update in a state in which copying of valid page(s) is not normally completed, the map manager 44 may not perform a map update (i.e., an update of the mapping table). This is due to the map request being issued with old physical is information if the state manger 42 requests a map update and a valid page copy is completed later. The map manager 44 may perform a map update to ensure accuracy only if the latest map table still points to the old physical address.

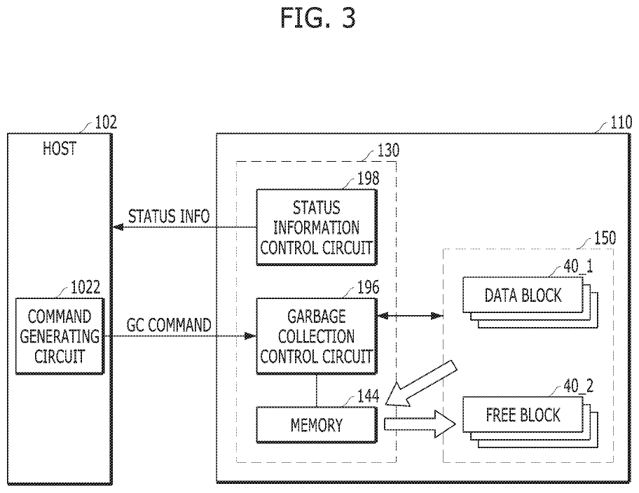

In accordance with an embodiment, at least one of the block manager 48, the map manager 44, and the state manager 42 of FIG. 2, may include a garbage collection control circuit 196 described later in FIG. 3.

The memory device 150 may include a plurality of memory blocks. Each of the plurality of memory blocks may be implemented as any of various types, such as a single level cell (SLC) memory block and a multi level cell (MLC) memory block, according to the number of bits that can be stored or represented in one memory cell of that memory block. The SLC memory block includes a plurality of pages implemented by memory cells, each storing one bit of data. The SLC memory block may have high performance of data input and output (I/O) operation, and high durability. The MLC memory block includes a plurality of pages implemented by memory cells, each storing multi-bit data (e.g., two bits or more). The MLC memory block may have larger storage capacity in the same space, than the SLC memory block, The MLC memory block may be highly integrated in terms of storage capacity. In an embodiment, the memory device 150 may be implemented with MLC memory blocks such as an MLC memory block, a triple level cell (TLC) memory block, a quadruple level cell (QLC) memory block and a combination thereof. The MLC memory block may include a plurality of pages implemented by memory cells, each capable of storing 2-bit data. The triple level cell memory block may include a plurality of pages implemented by memory cells, each capable of storing 3-bit data. The quadruple level cell memory block may include a plurality of pages implemented by memory cells, each capable of storing 4-bit data. In another embodiment, the memory device 150 may be implemented with a block including a plurality of pages implemented by memory cells, each capable of storing 5-bit data or more.

In an embodiment of the disclosure, the memory device 150 is embodied as a nonvolatile memory for example as a flash memory, such as a NAND flash memory and a NOR flash memory. However, the memory device 150 may be implemented by at least one of a phase change random access memory (PCRAM), a ferroelectrics random access memory (FRAM) and a spin transfer torque magnetic random access memory (STT-RAM or STT-MRAM).

FIG. 3 is a diagram of garbage collection used in the memory system in accordance with the embodiment.

Referring to FIG. 3, according to an embodiment, garbage collection (GC) may be self-performed by the memory system 110 without a command transferred from the host 102. Also, according to an embodiment, garbage collection may be performed in the memory system 110 in response to a garbage collection command GC COMMAND inputted from the host 102.

The controller 130 may read user data from a plurality of data blocks 40_1 of the memory device 150 and store the user data in the memory 144 of the controller 130. The user data may be programmed in at least one free block 40_2 by the controller 130. The plurality of data blocks 40_1 may include a closed block that cannot be programmed with data any more. In accordance with an embodiment, the memory 144 may be disposed externally to the controller 130 and coupled with the controller 130.

In detail, the garbage collection control circuit 196 included in the controller 130 may self-start to perform garbage collection by checking the status of the memory device 150 or may perform garbage collection in response to the garbage collection command GC COMMAND inputted from the host 102.

Garbage collection performed through the garbage collection control circuit 196 included in the controller 130 will be described hereunder in detail.

Specifically, the garbage collection control circuit 196 of the controller 130 may select at least one of the plurality of data blocks 40_1 as a target block. The garbage collection control circuit 196 may search for the target block and extract valid data from the target block. The garbage collection control circuit 196 may copy the extracted valid data to the free block 40_2, which is erased and ready to be programmed with data. Data determined to be no longer valid in the target block may be discarded, and may not be copied to the free block 40_2. After all valid data previously stored in the target block are copied to the free block 40_2, the controller 130 considers that the target block 40_1 has no more valid data and that any data therein may be erased. Thus, when any block to be programmed with new data is required, all the data stored in the target block can be erased and the target block used to store the new data.

In accordance with an embodiment, the controller 130 may use the memory 144 to temporarily store valid data selected from the target block until the valid data are programmed into the free block 40_2.

For garbage collection, the controller 130 should distinguish valid data from invalid data in a target block. The information on the effective page count (VPC) corresponding to each data block 40_1 may indicate the amount of the valid data or valid pages in each data block 40_1, but may not show which data or which page in each data block 40_1 is valid or not. Therefore, the controller 130 may need to utilize the number of valid pages and operation information including a map data to determine or confirm which data or which page is valid or not. In an embodiment, when a valid data to be stored in the free block 40_2 is easily distinguished for garbage collection, resources (e.g., time and power) required for garbage collection may be reduced.

The plurality of blocks 40_1 and 40_2 in the memory device 150 may store a large amount of data. In accordance with an embodiment, the controller 130 may divide each block into a plurality of unit blocks in order to more efficiently control and manage the plurality of blocks 40_1 and 40_2. When a single block is divided into a plurality of unit blocks, the controller 130 may generate map data (e.g., a logical-to-physical (L2P) table, or a physical-to-logical (P2L) table) for each unit block.

In accordance with an embodiment, various numbers of unit blocks may be included in a single block. By way of example but not limitation, the number of unit blocks included in a single block may depend at least on the structure of the memory device 150, the size of the map data, or the location of the map data. In an embodiment, each block in the memory device 150 may be programmed with data in a single-page unit or a multi-page unit. The size of data that can be stored in each page may be varied according to the structure of unit cells or cell strings in each block. When a map data is generated in a bitmap format, an area corresponding to one or more times the size of the map data may be determined as the size of the unit block.

Data may be sequentially programmed from the first page to the last page in the data block 40_1. When data is programmed on the last page of a block, the block is changed from an open state where new data can be programmed to a closed state in which the new data can no longer be programmed. In accordance with an embodiment, when a specific block among the data blocks 40_1 becomes a closed state, the garbage collection control circuit 196 may compare the number of map data regarding the data stored in the unit block of the corresponding block with the number of valid pages to determine the validity of the data stored in the corresponding block.

Specifically, when the data block 40_1 of the memory device 150 is in the closed state, the controller 130 may compare the number of valid pages with the sum of map data for plural unit blocks. If the number of valid pages and the sum of the map data for a specific block are not matched with each other, it could be presumed that the specific block includes some invalid or unnecessary map data. The controller 130 may check whether the map data corresponding to the data stored in the specific block is valid. When there is map data that is no longer valid, the controller 130 may delete or invalidate invalid map data to update the map data.

In accordance with an embodiment, the garbage collection control circuit 196 may determine whether to designate a target block for garbage collection based on the ratio of the sum of map data for a plurality of unit blocks in a corresponding block divided by the number of pages in the corresponding block. In various embodiments, the number of pages in a block may be a fixed value determined by circuit design and manufacturing procedures of the memory device 150. The number of pages may represent the maximum amount of valid data that can be stored in the block. When a specific block is divided into a plurality of unit blocks and map data are generated for each unit block, the sum of map data for a plurality of unit blocks in the corresponding block may indicate the amount of valid data in the corresponding block. Therefore, the garbage collection control circuit 196 may recognize which block stores more valid data than another block, based on the ratio of the sum of the map data for the plurality of unit blocks in one block divided by the number of pages in the corresponding block. As the ratio regarding a block is lower, the garbage collection control circuit 196 may prioritize a block having a lower ratio as a target block for garbage collection. In addition, the garbage collection control circuit 196 may determine whether to select a block as the target block for the garbage collection depending on whether the ratio is within a set range or is below a threshold.

In the embodiments above-described, the controller 130 may search for valid data in a target block among a plurality of data blocks 40_1 for garbage collection. At this time, the controller 30 does not search for valid data in every data block 40_1 in the memory device 150, but instead may search for valid data only in data blocks 40_1 having a number of unit blocks within a set range. In this case, it is possible to reduce resources (e.g., time and power) required for searching for valid data to be stored in the free block 40_2 during the garbage collection.

The search for valid pages may be relevant to a sub-operation of garbage collection. The search for valid pages and the search for target blocks may be a key factor for managing the consumed time of garbage collection in a memory system. A method and an apparatus for performing the garbage collection would support the search for valid pages and the search for target blocks. Herein, the garbage collection may include an operation for searching for an area (e.g., a block) in which a dynamically allocated memory area is no longer usable or needlessly occupied, and erasing data stored in the corresponding area to prepare for programming new data. The time required to erase data contained in a specific area of a nonvolatile memory device may vary depending on cell structure or cell characteristics of the nonvolatile memory device. Furthermore, the time required to search for an area to be erased in the nonvolatile memory device may vary depending on a method and an apparatus for controlling the nonvolatile memory device in accordance with various embodiments.

In detail, the status information control circuit 198 included in the controller 130 may generate or update status information STATUS INFO by checking the number of free blocks 40_2 included in the memory device 150. The status information STATUS INFO generated or updated in the status information control circuit 198 may be outputted to the host 102.

The host 102 may include a command generating circuit 1022 for generating a command. In the types of commands generated in the command generating circuit 1022, there may be included the garbage collection command GC COMMAND for controlling the garbage collection of the memory system 110. Thus, the host 102 may check the status information STATUS INFO inputted from the memory system 110, and may selectively output the garbage collection command GC COMMAND through the command generating circuit 1022 depending on a result of the checking and at a time determined by the host based on, for example, a burst word load ending or when the host can tolerate performance degradation and the dirty level is high. That is, the host determines when the garbage collection occurs. As the garbage collection command GC COMMAND generated in the host 102 is transferred to the memory system 110, the garbage collection control circuit 196 included in the memory system 110 may perform garbage collection for the memory device 150.

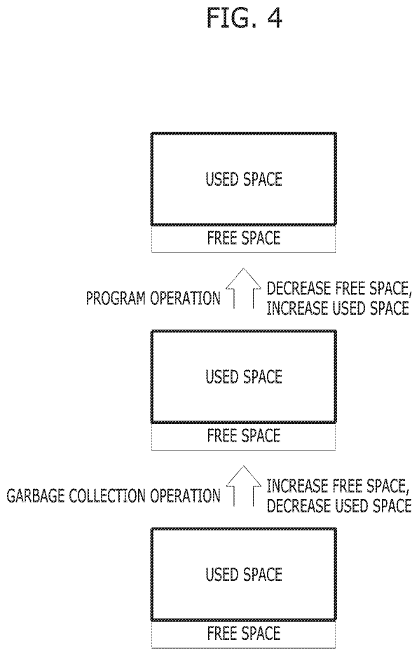

FIG. 4 is a diagram of a program operation and garbage collection of the memory system in accordance with the embodiment of the disclosure.

Referring to FIGS. 1 to 4, the storage space of the memory device 150 included in the memory system 110 may include a used space USED SPACE in which certain data is already stored and a free space FREE SPACE in which no data is stored.

If a program operation PROGRAM OPERATION is performed for the free space FREE SPACE, the size of the free space FREE SPACE may decrease, and the size of the used space USED SPACE may increase (DECREASE FREE SPACE, INCREASE USED SPACE).

When the size of the free space FREE SPACE decreases too much, garbage collection may be performed as a method for increasing the size of the free space FREE SPACE.

If garbage collection is performed, because invalid data may be collected and erased in the used space USED SPACE, the size of the free space FREE SPACE may increase, and the size of the used space USED SPACE may decrease (INCREASE FREE SPACE, DECREASE USED SPACE).

By decreasing the size of the used space USED SPACE and increasing the size of the free space FREE SPACE through garbage collection, it is possible to prevent the performance and endurance of the memory device 150 from deteriorating.

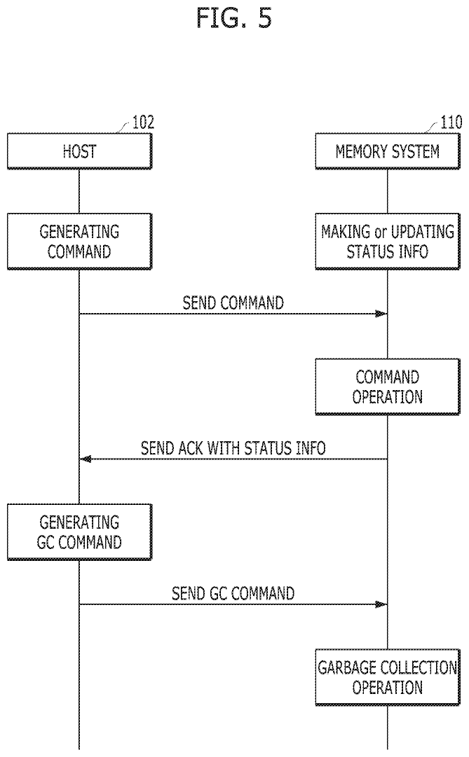

FIG. 5 is a diagram of a method for transmitting status information for garbage collection in accordance with an embodiment of the disclosure.

Referring to FIGS. 1 to 5, the host 102 may generate a command (GENERATING COMMAND). For example, the host 102 may generate a read command, a write (program) command and an erase command, and thereby, may control a read operation, a write (program) operation and an erase operation as foreground operations of the memory system 110. Also, the host 102 may generate a garbage collection command and a wear leveling command, and thereby, may control a garbage collection operation and a wear leveling operation as background operations of the memory system 110.

The memory system 110 may perform a command operation (COMMAND OPERATION) in response to a command (SEND COMMAND) inputted from the host 102. For example, in the case where a read command is inputted from the host 102, the memory system 110 may perform a read operation for the memory device 150 in response to the read command. In the case where a garbage collection command is inputted from the host 102, the memory system 110 may perform garbage collection for the memory device 150 in response to the garbage collection command. The memory system 110 may output an acknowledgement (SEND ACK) informing that the command operation (COMMAND OPERATION) has been performed, to the host 102.

The memory system 110 may generate or update status information STATUS INFO for garbage collection (GENERATING or UPDATING STATUS INFO). That is, the memory system 110 may generate or update the status information STATUS INFO by checking the number of free blocks among the plurality of memory blocks 152, 154 and 156 included in the memory device 150 therein. For example, the memory system 110 may generate the status information STATUS INFO in the case where the number of free blocks among the plurality of memory blocks 152, 154 and 156 included in the memory device 150 therein is less than a first preset reference. Also, the memory system 110 may update the status information STATUS INFO when the number of free blocks among the plurality of is memory blocks 152, 154 and 156 included in the memory device 150 therein changes by an amount greater than or equal to a second preset reference. Depending on a designer's choice, the first preset reference may be defined as an absolute number of free blocks or may be defined as a percentage of the number of free blocks with respect to the total number of the memory blocks 152, 154 and 156. Similarly, depending on a designer's choice, the second preset reference may be defined as an absolute number of changed free blocks or may be defined as a percentage of changed free blocks with respect to the total number of the memory blocks 152, 154 and 156.

When a generated or updated status information STATUS INFO exists, the memory system 110 sends the generated or updated status information STATUS INFO to the host 102. To send the generated or updated status information STATUS INFO to the host 102, the memory system 110 includes the generated or updated status information STATUS INFO in an acknowledgement to be sent to the host 102 corresponding to the command operation COMMAND OPERATION (SEND ACK WITH STATUS INFO). For example, if a command (not illustrated) is inputted from the host 102, the memory system 110 performs the command operation COMMAND OPERATION corresponding to the inputted command, and then, checks whether a generated or updated status information STATUS INFO exists. When, as a result of checking, a generated or updated status information STATUS INFO exists, the memory system 110 sends the generated or updated status information STATUS INFO to the host 102 by including the generated or updated status information STATUS INFO in an acknowledgement for informing that the command operation COMMAND OPERATION corresponding to the command inputted from the host 102 has been performed (SEND ACK WITH STATUS INFO). The command inputted from the host 102 may have no particular limitation. For example, the command inputted from the host 102 may be a command for controlling a foreground operation for the memory system 110, such as a read command, a write (program) command, and an erase command. Also, the command inputted from the host 102 may be a command for controlling a background operation for the memory system 110, such as a garbage collection command and a wear leveling command.

The host 102 checks the status information STATUS INFO inputted from the memory system 110, and then, depending on a result of the checking, generates a garbage collection command (GENERATING GC COMMAND) and sends the garbage collection command to the memory system 110 (SEND GC COMMAND). For example, as a result of checking the status information STATUS INFO inputted from the memory system 110, when the number of free blocks included in the memory device 150 is less than a third preset reference, the host 102 generates a garbage collection command (GENERATING GC COMMAND) and sends the garbage collection command to the memory system 110 (SEND GC COMMAND). Depending on a designer's choice, the third preset reference may be defined as an absolute number of free blocks or may be defined as a percentage of the number of free blocks with respect to the total number of the memory blocks 152, 154 and 156. However, the third preset reference is less than the first preset reference. For example, when the number of free blocks is less than or equal to 20 as the first preset reference, the memory system 110 generates the status information STATUS INFO. When the number of free blocks is less than or equal to 10 as the third preset reference, the host 102 generates a garbage collection command. As exemplified above, the third preset reference may be defined as a value less than the first preset reference.

The memory system 110 may perform garbage collection GARBAGE COLLECTION in response to the garbage collection command inputted from the host 102. As the memory system 110 performs garbage collection according to a request of the host 102, the number of free blocks included in the memory device 150 will increase.

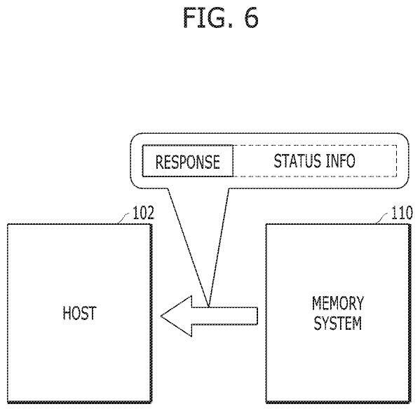

FIG. 6 is a diagram of a transaction of the host and the memory system in the data processing system in accordance with the embodiment of the disclosure.

Referring to FIG. 6, the memory system 110 may transfer status information STATUS INFO to the host 102. The memory system 110 may transfer the status information STATUS INFO by using a response RESPONSE to a command of the host 102.

The response RESPONSE for transmitting status information may have no particular limitation. For example, the memory system 110 may transmit status information to the host 102, by using a response corresponding to a read command, a response corresponding to a write command, or a response corresponding to an erase command.

The memory system 110 and the host 102 may exchange a command and a response according to a unit type set depending on a preset protocol. For example, the type of the response RESPONSE may include a basic header, a command due to a success or a failure of a command transferred from the host 102, and additional information indicating the status of the memory system 110. The memory system 110 may transfer status information to the host 102, by including the status information in the response RESPONSE.

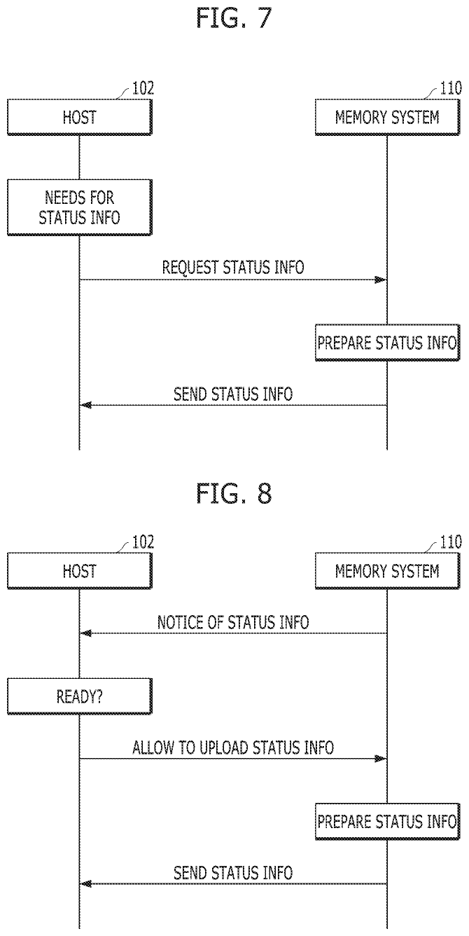

FIG. 7 is a diagram of a first operation of the host and the memory system in accordance with the embodiment of the disclosure. FIG. 7 illustrates a process in which the host 102 requests status information to the memory system 110 and the memory system 110 transmits the status information corresponding to the request of the host 102.

Referring to FIG. 7, requirements for status information may occur in the host 102. For example, when the host 102 determines that there is a time margin for performing garbage collection in the is memory system 110 or when the performance of the memory system 110 has deteriorated it is desirable to check whether the memory system 110 requires garbage collection, status information may be required by the host 102. Furthermore, a user's request for status information may occur in the host 102.

The host 102 may request status information to the memory system 110, and the memory system 110 may prepare status information corresponding to the request of the host 102. According to an embodiment, the host 102 may request necessary status information to the memory system 110 in a detailed manner.

The memory system 110 may transfer the prepared status information to the host 102.

FIG. 8 is a diagram of a second operation of the host and the memory system in accordance with the embodiment of the disclosure. FIG. 8 illustrates a process in which the memory system 110 requests that status information be transferred to the host 102 and the host 102 receives the status information in response to the request of the memory system 110.

Referring to FIG. 8, the memory system 110 may transfer a notice to send status information, to the host 102. Corresponding to the notice for status information which is transmitted from the memory system 110, the host 102 may check the status information, and depending on a result of the checking, may check whether it is possible to generate a garbage collection command. When the host is 102 receives the status information transmitted from the memory system 110, the host 102 may allow the memory system 110 to transmit the status information. The memory system 110 may prepare the status information to be transmitted to the host 102, and then, may transmit the status information to the host 102.

In relation with the transmission of the status information, a difference may exist in that, while the operations of the host 102 and the memory system 110 described above with reference to FIG. 7 are mainly performed by the host 102, the operations of the host 102 and the memory system 110 described with reference to FIG. 8 are mainly performed by the memory system110. According to an embodiment, the memory system 110 and the host 102 may selectively use the methods for transmitting status information, described above with reference to FIGS. 7 and 8, depending on operation environment.

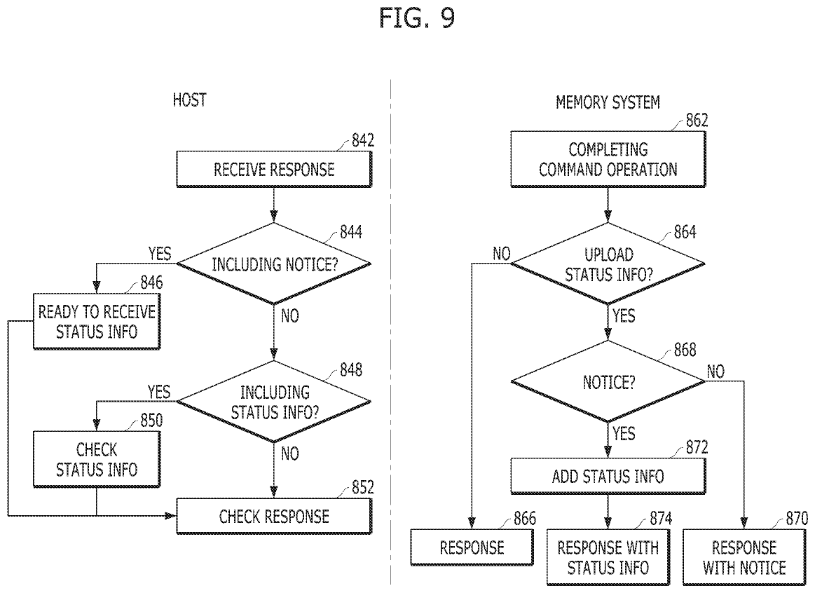

FIG. 9 is a diagram of a third operation of the host and the memory system in accordance with the embodiment of the disclosure. FIG. 9 illustrates a case where the memory system 110 is about to transmit status information to the host 102 during a process in which the host 102 and the memory system 110 cooperate with each other.

Referring to FIG. 9, the memory system 110 may check whether an operation corresponding to a command transferred from the host 102 is completed (862). After the operation corresponding to the command is completed, the memory system 110 may check whether there is status information to be transmitted to the host 102, before transmitting a response corresponding to the command (864). If there is no status information to be transmitted to the host 102 (NO of 864), the memory system 110 may transmit the response including information on whether the operation corresponding to the command transferred from the host 102 is completed or not (a success or a failure) (866).

When there is status information to be transmitted to the host 102 by the memory system 110 (YES of 864), the memory system 110 may check whether a notice for transmitting the status information has been generated (868). The notice may be similar to that described above with reference to FIG. 8. Even though the memory system 110 wants to transmit status information, if a notice related with the transmission of the status information to the host 102 by the memory system 110 has not been generated in advance (NO of 868), the memory system 110 may transfer the notice to the host 102 by adding the notice to a response (870).

When a notice for transmitting status information has already been generated (YES of 868), the memory system 110 may add the status information to a response (872). Thereafter, the memory system 110 may transmit the response including the status information (874).

The host 102 may receive at least one of the response RESPONSE, the response including the notice RESPONSE WITH NOTICE and the response including the status information RESPONSE WITH STATUS INFO transmitted from the memory system 110 (842).

The host 102 may check whether a notice is included in a received response (844). If a notice is included in a received response (YES of 844), the host 102 may be ready to receive and store status information which may be subsequently transferred (846). Thereafter, the host 102 may check the response corresponding to a previous command (852). For example, by checking the response, the host 102 may check whether the previous command has succeeded or failed.

When a notice is not included in a received response (NO of 844), the host 102 may check whether status information is included in the response (848). When status information is not included in the response (NO of 848), the host 102 may check the response corresponding to the previous command (852).

When status information is included in the received response (YES of 848), the host 102 may store the status information included in the response, in a storage space inside the host 102, or may update an already stored status information (850). Thereafter, the host 102 may check the response corresponding to the previous command (852).

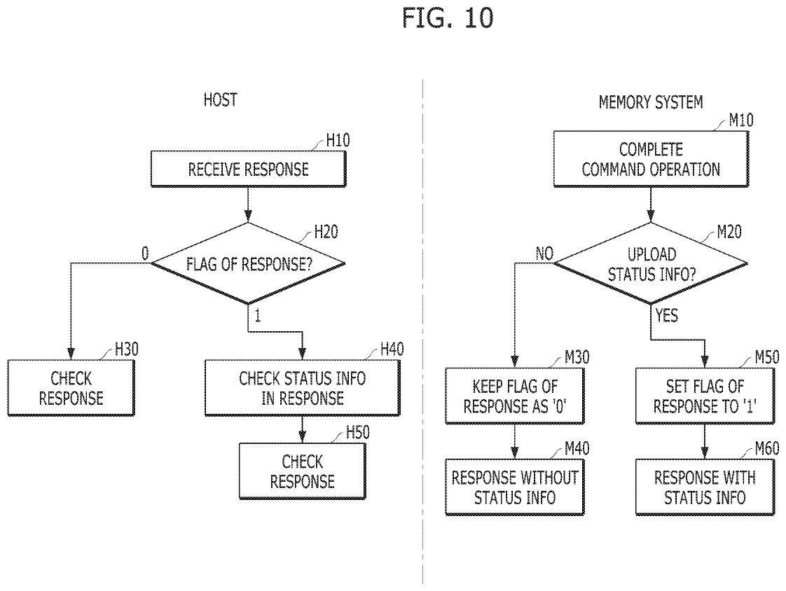

FIG. 10 is a diagram of a fourth operation of the host and the memory system in accordance with the embodiment of the disclosure. FIG. 10 illustrates a case where the memory system 110 is about to transmit status information to the host 102 by using a flag during a process in which the host 102 and the memory system 110 cooperate with each other.

First, referring to FIGS. 1 to 10, a flag may be included in a response to a command, which is to be sent to the host 102 by the memory system 110, and the default value of the flag may be ‘0.’

Referring to FIG. 10, the memory system 110 may check whether an operation corresponding to a command transferred from the host 102 is completed (M10). After the operation corresponding to the command is completed, the memory system 110 may check whether there is status information to be transmitted to the host 102, before transmitting a response corresponding to the command (M20). If there is no status information to be transmitted to the host 102 (NO of M20), the memory system 110 maintains the value of the flag included in the response corresponding to the command, as the default value of ‘0’ (M30). The memory system 110 may transmit the response including information on whether the operation corresponding to the command transferred from the host 102 is completed (a success or a failure), and status information is not included (M40).

When there is status information to be transmitted to the host 102 by the memory system 110 (YES of M20), the memory system 110 sets the value of the flag included in a response corresponding to a command, to ‘1’ (M50). The memory system 110 may transmit the response including information on whether the operation corresponding to the command transferred from the host 102 is completed (a success or a failure), and status information is included (M60).

The host 102 may receive at least one of the response including the status information RESPONSE WITH STATUS INFO and the response not including the status information RESPONSE WITHOUT STATUS INFO from the memory system 110 (H10).

The host 102 may check whether status information is included, through the value of the flag of a received response (H20). If the value of the flag of a received response is ‘0,’ it may be determined that status information is not included (0 of H20). Therefore, the host 102 may check the response corresponding to a previous command (H30).

If the value of the flag of a received response is ‘1,’ it may be determined that status information is included (1 of H20). Therefore, the host 102 may check the status information included in the response (H40). Also, separately from checking the status information included in the response, the host 102 may check the response corresponding to the previous command (H50).

As is apparent from the above-described embodiments, a memory system may transmit status information for garbage collection to a host. The memory system may process a command transmitted by the host and then transmit the status information by using an acknowledgement corresponding to the corresponding command. The host may check the status information inputted from the memory system, and may control whether to perform garbage collection for the memory system, depending on a result of the checking. Therefore, through the control of the host or a computing device, it is possible to prevent the performance and endurance of the memory system from deteriorating.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a nonvolatile memory device including a plurality of memory blocks; and
a controller suitable for checking a number of free blocks among the plurality of memory blocks, generating or updating status information depending on a result of the checking, and outputting the status information by including the status information in a response to be outputted to a host in response to a command inputted from the host.

2. The memory system according to claim 1, wherein the controller generates the status information when the number of free blocks among the blocks is less than a first preset reference.

3. The memory system according to claim 2, wherein the controller updates the status information when the number of free blocks among the blocks changes by an amount greater than or equal to a second preset reference.

4. The memory system according to claim 3, wherein the controller outputs the status information by including the status information in the response when the generated or updated status information exists after the operation corresponding to the command inputted from the host is performed.

5. The memory system according to claim 4,
wherein the response includes a flag, and
wherein the controller sets the flag when the status information is included in the response.

6. A data processing system comprising:
a host suitable for generating and outputting a command; and
a memory system including a nonvolatile memory device which includes a plurality of memory blocks,
wherein the memory system checks a number of free blocks among the plurality of memory blocks, and generates or updates status information depending on a result of the checking,
wherein the memory system outputs the status information by including the status information in a response to be outputted to the host in response to a command inputted from the host, and
wherein the host selectively generates a garbage collection command depending on the status information transferred from the memory system, and outputs the garbage collection command to the memory system at a time determined by the host.

7. The data processing system according to claim 6, wherein the memory system generates the status information when the number of free blocks among the blocks is less than a first preset reference.

8. The data processing system according to claim 7, wherein the memory system updates the status information when the number of free blocks among the blocks changes by an amount greater than or equal to a second preset reference.

9. The data processing system according to claim 8, wherein the memory system outputs the status information by including the status information in the response when the generated or updated status information exists after the operation corresponding to the command inputted from the host is performed.

10. The data processing system according to claim 9, wherein the host checks the status information included in the response.

11. The data processing system according to claim 10
wherein the response includes a flag, and
wherein the memory system sets the flag when the status information is included in the response.

12. The data processing system according to claim 11, wherein the host checks the flag included in the response, checks the status information included in the response when the flag is in a set state, selectively generates the garbage collection command depending on a result of the checking of the status information and outputs the garbage collection command to the memory system at a time determined by the host.

13. The data processing system according to claim 10,
wherein the host generates the garbage collection command when the number of free blocks among the memory blocks is less than a third preset reference, and
wherein the third preset reference is less than the first preset reference.

14. A method for operating a memory system including a nonvolatile memory device which includes a plurality of memory blocks, the method comprising:
checking a number of free blocks among the memory blocks and generating or updating status information depending on a result of the checking; and
outputting the status information by including the status information in a response to be outputted to a host in response to a command inputted from the host.

15. The method according to claim 14, wherein checking the number of free blocks includes:
a first checking step of checking whether the number of free blocks among the memory blocks is less than a first preset reference; and
generating the status information when the number of free blocks is less than the first preset reference.

16. The method according to claim 15, wherein checking the number of free blocks further includes:
a second checking step of checking whether the number of free blocks among the memory blocks changes by an amount greater than or equal to a second preset reference; and
updating the status information when the number of free blocks changes by an amount greater than or equal to the second preset reference.

17. The method according to claim 16, wherein outputting the status information includes:
a third checking step of checking whether the generated or updated status information exists; and
outputting the status information by including the status information in the response when the generated or updated status information exists.

18. The method according to claim 17,
wherein the response includes a flag, and
wherein outputting the status information further includes setting the flag when the status information is included in the response.

19. A method for operating a data processing system including a host capable of generating and outputting a command, and a memory system including a nonvolatile memory device which includes a plurality of memory blocks, the method comprising:
checking, by the memory system, a number of free blocks among the memory blocks and generating or updating, by the memory system, status information depending on a result of checking the number of free blocks;
generating, by the host, a command and outputting, by the host, the command to the memory system;
a first outputting step of including, by the memory system, the status information in a response to be outputted to the host after performing an operation in response to the command; and
a second outputting step of checking, by the host, the status information included in the response, selectively generating, by the host, a garbage collection command depending on a result of checking the status information and outputting the garbage collection command to the memory system at a time determined by the host.

20. The method according to claim 19, wherein checking, by the memory system, a number of free blocks includes:
a first checking step of checking whether the number of free blocks among the memory blocks is less than a first preset reference; and
generating the status information when the number of free blocks is less than the first preset reference.

21. The method according to claim 20, wherein checking, by the memory system, a number of free blocks further includes:
a second checking step of checking whether the number of free blocks among the memory blocks changes by and amount greater than or equal to a second preset reference; and
updating the status information when the number of free blocks changes by an amount greater than or equal to the second preset reference.

22. The method according to claim 21, wherein the first outputting step comprises:
a third checking step of checking whether the generated or updated status information exists; and
outputting the status information by including the status information in the response when the generated or updated status information exists.

23. The method according to claim 22,
wherein the response includes a flag, and
wherein the second outputting step includes:
a fourth checking step of checking the flag by the host; and
checking, by the host, the status information included in the response and selectively generating, by the host, the garbage collection command depending on a result of the checking the status information and outputting, by the host, the garbage collection command to the memory system, when the flag is in a set state and at a time determined by the host.

24. The method according to claim 19,
wherein the garbage collection command is generated when the number of free blocks among the memory blocks is less than a third preset reference, and
wherein the third preset reference is less than the first preset reference.

25. An operating method of a data processing system including a host and a memory system, the operating method comprising:
performing, by the memory system, an operation in response to a request provided from the host;
providing, by the memory system, the host with information of currently available memory space thereof along with a response to the request; and
selectively controlling, by the host, the memory system to secure available memory space thereof based on the information and at a time determined by the host.

26. The operating method of claim 25, wherein the information is provided when the currently available memory space is under a first threshold.

27. The operating method of claim 26, wherein the host controls the memory system to secure the available memory space when the currently available memory space is under a second threshold less than the first threshold.

28. An operating method of a memory system, the operating method comprising:
performing an operation in response to a first request provided from a host;
providing the host with information of currently available memory space thereof along with a response to the first request; and
securing available memory space thereof in response to a second request provided from the host.

29. The operating method of claim 28, wherein the information is provided when the currently available memory space is under a first threshold.

30. The operating method of claim 29, wherein the available memory space is secured in response to the second request when the currently available memory space is under a second threshold less than the first threshold.
